(19) United States
(12) Patent Application Publication
(10) Pub. No.: US 2018/0309281 A1
(43) Pub. Date: Oct. 25, 2018

(54) LAMINATED BUS BAR AND BATTERY MODULE

(71) Applicant: Yazaki Corporation, Tokyo (JP)

(72) Inventors: Yoshiaki Ichikawa, Shizuoka (JP); Toshitaka Iwasaki, Shizuoka (JP); Yutaka Wakatsuki, Shizuoka (JP); Satoshi Hishikura, Shizuoka (JP); Hiroki Kayamori, Shizuoka (JP)

(21) Appl. No.: 15/955,659

(22) Filed: Apr. 17, 2018

(30) Foreign Application Priority Data
Apr. 21, 2017 (JP) 2017-084110

(51) Int. Cl. H02G 5/00; H01M 10/6553; H01R 11/01; H01M 2/20; H01M 2/10; H01R 11/28

(52) U.S. Cl. CPC H02G 5/005; H01M 10/6553; H01R 11/01; H01R 2201/26; H01M 2/1077; H01R 11/288; H01M 2/206

(57) ABSTRACT

A battery module includes laminated bus bars and which connect respective battery packs. Each of the laminated bus bars includes a plurality of bus bars formed in an identical shape. Each of the bus bars includes connecting portions which are formed at both ends in a first direction and electrically connect the battery packs and a deformation allowing portion which is formed between the connecting portions and is curved in a plate thickness direction as viewed in a second direction. The laminated bus bars are formed by laminating the bus bars such that the deformation allowing portions overlap with each other in the plate thickness direction and the connecting portions of the bus bars adjacent to each other are in contact with each other.

### CROSS-REFERENCE TO RELATED APPLICATION(S)

The present application claims priority to and incorporates by reference the entire contents of Japanese Patent Application No. 2017-084110 filed in Japan on Apr. 21, 2017.

### BACKGROUND OF THE INVENTION

### 1. Field of the Invention

The present invention relates to a laminated bus bar and a battery module.

### 2. Description of the Related Art

Conventionally, in electric cars and hybrid cars, a plurality of battery packs for supplying electric power to various in-vehicle electrical components are modularized, and a battery module is mounted on a vehicle. Each of the battery packs in the battery module is configured by integrating a plurality of battery cells inside a housing. In electrical connection of a plurality of the battery packs, in some cases, laminated bus bars may be used. The laminated bus bar is formed by laminating plate-shaped conductive bus bars in the plate thickness direction and electrically connecting the end electrode terminals between the battery packs.

In the above-described battery cell, heat dissipation and expansion and contraction of an external shape may occur when applying current, so that the separation distances between the end electrode terminals between the battery packs may be changed. Therefore, a deformation allowing portion which absorbs the change in the separation distance is formed in the laminated bus bar (refer to Japanese Patent Application Laid-open No. 2012-182043).

In the laminated bus bars, a lamination number of the bus bars laminated differs according to the current value flowing between battery packs. In addition, the bus bars in the laminated bus bar are formed to have different lengths of the deformation allowing portion and lengths in an extension direction according to the lamination order. For this reason, the laminated bus bars having different shapes are managed so as to be distinguished from each other, and in assembling, the operator forms the laminated bus bar by laminating the bus bars according to the lamination order. Therefore, in order to prepare a plurality of the laminated bus bars having different lamination numbers of the bus bars, the bus bars having different shapes are required, and molds for forming the bus bars having different shapes are required. In addition, in the assembling of the laminated bus bar, the operator needs to perform lamination work without making a mistake of the lamination order while distinguishing the bus bars having different shapes. In these respects, the laminated bus bar has room for improvement.

### SUMMARY OF THE INVENTION

The present invention is to provide a laminated bus bar and a battery module that can be easily formed.

In order to achieve the above mentioned object, a laminated bus bar according to one aspect of the present invention includes a plurality of bus bars formed in an identical shape, wherein each of the bus bars is a plate-shaped conductive member formed to extend in a first direction, each of the bus bars includes: connecting portions formed at both ends in the first direction and electrically connect battery packs, each of the battery packs including a plurality of battery cells; and a deformation allowing portion that is formed between the connecting portions and is curved in a plate thickness direction as viewed in a second direction perpendicular to the first direction, and the bus bars are laminated such that the deformation allowing portions overlap with each other in the plate thickness direction, and the connecting portions of the bus bars adjacent to each other are in contact with each other.

According to another aspect of the present invention, the laminated bus bar may further include a covering member that has an insulating property, is made of a resin and covers an outer periphery of the bus bars in a laminated state, wherein the covering member may be formed such that at least the deformation allowing portions are located in the covering member, and the connecting portions are exposed to an outside of the covering member.

In order to achieve the above mentioned object, a battery module according to still another aspect of the present invention includes a plurality of battery packs that include a plurality of battery cells therein; and a plurality of laminated bus bars that include a plurality of bus bars formed in an identical shape, wherein in the plurality of battery packs, in a case where at least two battery packs having the same number of battery cells are configured as a set of a battery pack group, at least two or more sets of the battery pack group exist, and in a case where the sets are different from each other, the number of battery cells in the one battery pack differs, each of the bus bars is a plate-shaped conductive member formed to extend in a first direction, each of the bus bars includes: connecting portions formed at both ends in the first direction and electrically connect the battery packs, each of the battery packs including the plurality of battery cells; and a deformation allowing portion that is formed between the connecting portions and is curved in a plate thickness direction as viewed in a second direction perpendicular to the first direction, the bus bars are laminated such that the deformation allowing portions overlap with each other in the plate thickness direction, and the connecting portions of the bus bars adjacent to each other are in contact with each other, and a lamination number of the plurality of laminated bus bars differs according to a current value flowing between the battery packs to be connected or between the battery pack groups to be connected.

The above and other objects, features, advantages and technical and industrial significance of this invention will be better understood by reading the following detailed description of presently preferred embodiments of the present invention, when considered in connection with the accompanying drawings.

### BRIEF DESCRIPTION OF THE DRAWINGS

FIG. 1 is a perspective view illustrating a battery module according to an embodiment;

FIG. 2 is a perspective view illustrating a laminated bus bar according to an embodiment; and

FIG. 3 is a partial view illustrating the laminated bus bar according to the embodiment.

### DETAILED DESCRIPTION OF THE PREFERRED EMBODIMENTS

Hereinafter, embodiments of a laminated bus bar and a battery module according to the present invention will be described in detail with reference to the drawings. In addition, the present invention is not limited by this embodiment. In addition, components in the following embodiments include those that can be easily assumed by those skilled in the art or substantially the same. In addition, components in the following embodiments can be variously omitted, replaced, and changed without departing from the spirit of the present invention.

### Embodiment

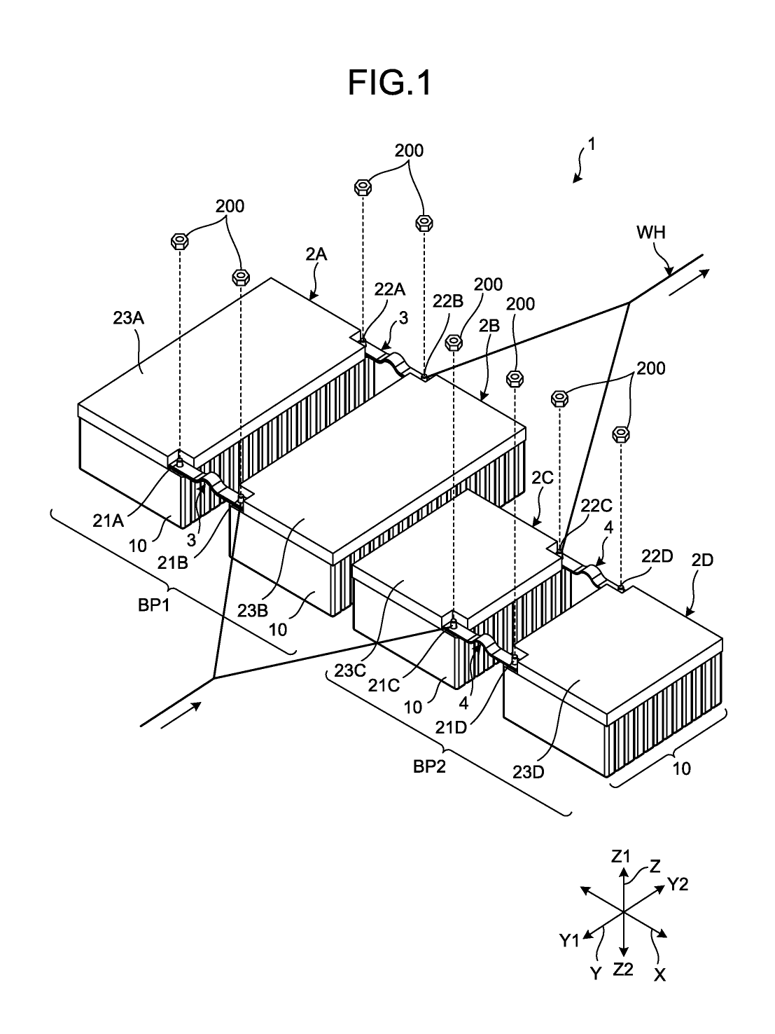

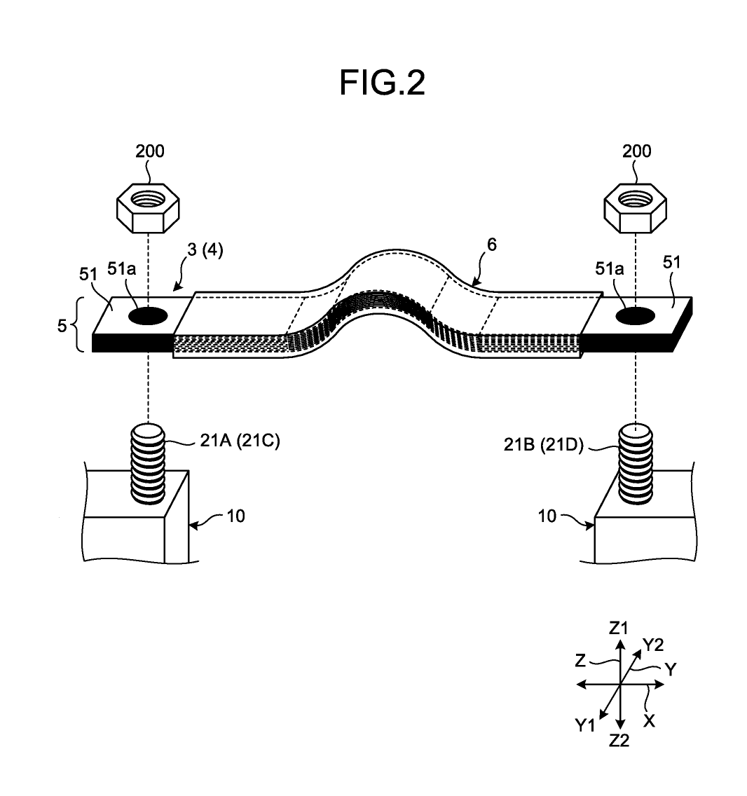

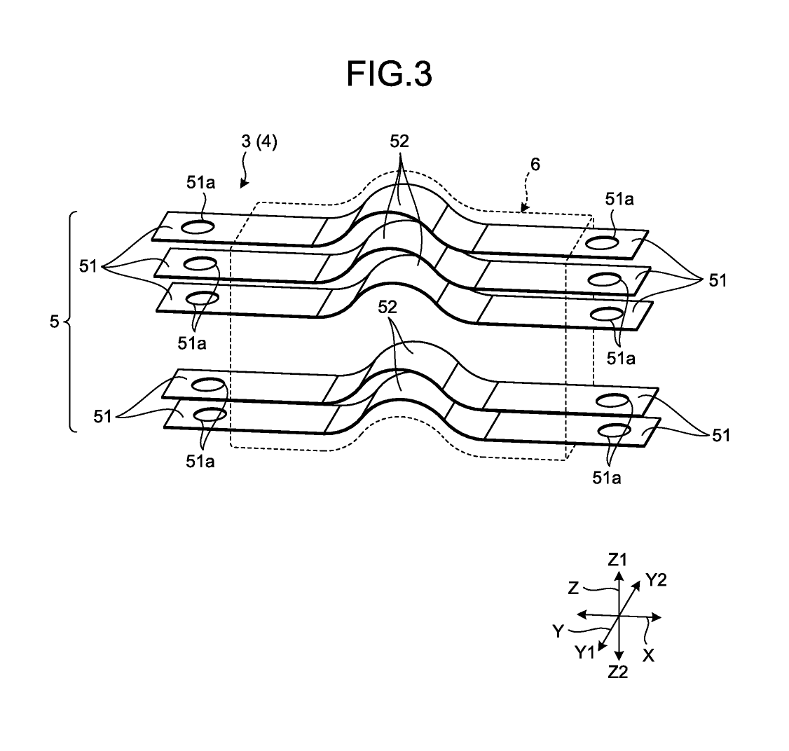

First, a laminated bus bar and a battery module according to an embodiment will be described. FIG. 1 is a perspective view illustrating the battery module according to the embodiment. FIG. 2 is a perspective view illustrating a laminated bus bar according to the embodiment. FIG. 3 is a partial view illustrating the laminated bus bar according to the embodiment. An X direction in each figure is an extension direction of the laminated bus bar and is a first direction. In addition, the direction is an arrangement direction of the battery packs. A Y direction in each figure is a direction perpendicular to the extension direction of the laminated bus bar and is a second direction. In addition, the direction is an arrangement direction of the battery cells in the battery pack. A Y1 direction is the current input direction, and a Y2 direction is the current output direction. A Z direction in each figure is a vertical direction and is a direction perpendicular to the first direction and the second direction. In addition, the direction is a plate thickness direction of the bus bar in the laminated bus bar. A Z1 direction is the upward direction, and a Z2 direction is the downward direction.

A battery module 1 is mounted on an electric car or a hybrid car. In the battery module 1, an external current flows to the battery module 1 and supplies electric power stored in a battery cell 10 described later to various on-vehicle electrical components such as a junction box and an inverter. As illustrated in FIG. 1, the battery module 1 includes battery packs 2A to 2D, laminated bus bars 3 and 4, and a plurality of battery cells 10. The battery module 1 accommodates the battery packs 2A to 2D and the laminated bus bars 3 and 4 in a housing (not illustrated). As a result, the battery packs 2A to 2D are integrated into one, and the battery packs 2A to 2D are modularized.

The battery packs 2A to 2D are integrated bodies of a plurality of the battery cells 10. Herein, the battery cell 10 functions as a battery for storing electric power, and the battery cells are arranged along the second direction in each of the battery packs 2A to 2D. The battery cell 10 has electrode terminals at ends facing in the first direction. In the electrode terminals, one of the electrode terminals is a positive electrode, and the other is a negative electrode. In each of the battery packs 2A to 2D, a plurality of the battery cells 10 are arranged such that electrode terminals adjacent to each other in the second direction are alternately located with positive and negative electrode terminals. The battery packs 2A to 2D include end electrode terminals 21A to 21D and 22A to 22D and bus bar modules 23A to 23D, respectively.

The end electrode terminals 21A to 21D and 22A to 22D are provided in the battery packs 2A to 2D, respectively. In this embodiment, the end electrode terminals 21A and 22A are provided in the battery pack 2A, the end electrode terminals 21B and 22B are provided in the battery pack 2B, the end electrode terminals 21C and 22C are provided in the battery pack 2C, and the end electrode terminals 21D and 22D are provided in the battery pack 2D. Each of the end electrode terminals 21A to 21D and 22A to 22D is one of the electrode terminals of the battery cells 10 located at both ends in the second direction. Therefore, the end electrode terminals 21A to 21D and 22A to 22D are located opposite to each other in the second direction in the respective battery packs 2A to 2D. The end electrode terminals 21A to 21D are the same positive and negative electrodes, and the end electrode terminals 22A to 22D are the same positive and negative electrodes. The end electrode terminals 21A to 21D and 22A to 22D are exposed to the outside of the bus bar modules 23A to 23D in the state where the bus bar modules 23A to 23D are electrically connected to the electrode terminals of the battery cells 10 of the respective battery packs 2A to 2D.

The bus bar modules 23A to 23D electrically connect the electrode terminals adjacent to each other in the second direction in the plurality of battery cells 10 in the respective battery packs 2A to 2D, and a voltage detector (not illustrated) is connected to detect a voltage between the plurality of battery cells 10 in each of the battery packs 2A to 2D. The bus bar modules 23A to 23D are located on the side of the battery cells 10 which is closer to the electrode terminals, that is, the upper side of the battery cells 10, and are electrically connected to the electrode terminals of the battery cells 10. In this embodiment, as described above, the electrode terminals adjacent to each other in the second direction are alternately arranged with the positive electrode and the negative electrode. Therefore, the bus bar modules 23A to 23D electrically connect the electrode terminals adjacent to each other in the second direction, so that the plurality of battery cells 10 in each of the battery packs 2A to 2D are connected in series.

Herein, the amount of electric power that can be electrically charged by the battery cell 10, that is, the battery capacity is different among the battery packs 2A to 2D. In this embodiment, the battery packs 2A and 2B have the same number of battery cells 10, and the battery packs 2C and 2D have the same number of battery cells 10. In addition, the battery packs 2A and 2B have a larger number of battery cells 10 than the battery packs 2C and 2D. That is, the battery packs 2A and 2B have a larger battery capacity than the battery packs 2C and 2D.

The battery packs 2A to 2D are arranged in the first direction with respect to the installation region on the vehicle side. In the battery packs 2A to 2D, the battery pack 2A and the battery pack 2B having the same number of battery cells 10 and battery pack 2C and battery pack 2D having the same number of battery cells 10 are arranged adjacent to each other in the first direction, respectively. The battery packs 2A and 2B are arranged such that the end electrode terminals 21A and 22A of the battery pack 2A and the end electrode terminals 21B and 22B of the battery pack 2B face each other adjacently in the first direction. Similarly, the battery packs 2C and 2D are arranged such that the end electrode terminals 21C and 22C of the battery pack 2C and the end electrode terminals 21D and 22D of the battery pack 2D face each other adjacently in the first direction.

As illustrated in FIGS. 1 to 3, the laminated bus bars 3 and 4 electrically connect the battery packs 2A and 2B and the battery packs 2C and 2D, respectively. The laminated bus bars 3 and 4 are electrically connected to the end electrode terminals 21A and 21B and the end electrode terminals 22A and 22B and to the end electrode terminals 21C and 21D and the end electrode terminals 22C and 22D between the battery packs 2A to 2D, respectively. The electrode terminals including the end electrode terminals 21A to 21D and 22A to 22D in this embodiment are used in the state where two stud bolts are vertically installed at the ends in the longitudinal direction of the main body of the battery cell 10. Therefore, after the laminated bus bars 3 and 4 are electrically connected to the respective end electrode terminals 21A to 21D and 22A to 22D, nuts 200 as fastening members are passed through the end electrode terminals 21A to 21D and 22A to 22D and tightened, so that the nuts are engaged with the end electrode terminals 21A to 21D and 22A to 22D. The laminated bus bars 3 and 4 are formed in a rectangular shape having the same outer shape as viewed in the vertical direction. Each of the laminated bus bars 3 and 4 includes a plurality of bus bars 5 and a covering member 6. Each of the laminated bus bars 3 and 4 is formed by laminating a plurality of the bus bars 5 in the plate thickness direction.

The bus bars 5 have an identical shape. The bus bar 5 is formed to extend in the first direction and is a plate-shaped member formed of a conductive metal or the like. The bus bar 5 is formed in a rectangular shape as viewed in the vertical direction. The bus bar 5 includes connecting portions 51 and a deformation allowing portion 52.

The connecting portions 51 are formed at both ends of the bus bar 5 in the first direction. The connecting portions 51 are electrically connected to the end electrode terminals 21A to 21D of the respective battery packs 2A to 2D. Therefore, each of the connecting portions 51 is formed with a through hole 51a penetrating the bus bar 5 in the plate thickness direction, and the end electrode terminals 21A to 21D and 22A to 22D pass through the through hole 51a. The diameter of the through hole 51a is formed to be larger than the diameters of the end electrode terminals 21A to 21D and 22A to 22D. The connecting portion 51 is in contact with the connecting portion 51 of the bus bar 5 adjacent in the plate thickness direction in the state where the bus bars 5 in the laminated state are covered with the covering member 6 described later.

The deformation allowing portion 52 is formed between the connecting portions 51 in the bus bar 5. As viewed in the second direction, the deformation allowing portion 52 is formed in an arc shape where the bus bar 5 is curved in the plate thickness direction. Therefore, in a case where the separation distances between the end electrode terminals 21A and 22A and the end electrode terminals 21B and 22B and between the end electrode terminals 21C and 22C and the end electrode terminals 21D and 22D between the battery packs 2A to 2D are changed, in the bus bar 5, the separation distance between the connecting portions 51 in the first direction is changed by deforming the arc shape such that the width of the deformation allowing portion 52 in the first direction is changed. With respect to the deformation allowing portions 52, in the state where the bus bars 5 in the laminated state are covered with the covering member 6 described later, the curving directions of the deformation allowing portions 52 of the bus bars 5 are the same direction, and the deformation allowing portions 52 of the bus bars 5 adjacent to each other in the plate thickness direction are in contact with each other.

The covering member 6 is formed by covering the outer periphery of the bus bars 5 in the laminated state with a resin member having an insulating property. The covering member 6 protects the laminated bus bars 3 and 4 from a short circuit with an external member and an external force. The covering member 6 integrally retains the bus bars 5 laminated. The covering member 6 is formed in the extension direction of the bus bars 5 in the laminated state and is formed such that the deformation allowing portions 52 are located therein and the through holes 51a are exposed to the outside of the covering member 6. The covering member 6 is formed by insert-molding the bus bars 5 in the laminated state. In addition, the covering member 6 may be a rubber member such as silicone rubber.

The lamination number of the bus bars 5 in each of the laminated bus bars 3 and 4 is set in advance to correspond to the current value flowing in each of the laminated bus bars 3 and 4. In other words, the lamination number of the bus bars 5 is calculated and set in advance such that each of the laminated bus bars 3 and 4 has a current-carrying capacity in consideration of a maximum current value flowing through each of the laminated bus bars 3 and 4. In other words, the laminated bus bars 3 and 4 are different in terms of the lamination number of the bus bars 5, so that the current-carrying capacities thereof are different. Herein, as described above, since the battery packs 2A and 2B have a larger battery capacity than the battery packs 2C and 2D, when the battery packs 2A and 2B and the battery packs 2C and 2D are electrically connected to electrically conduct with each other, the current value flowing between the battery packs 2A and 2B is larger than the current value flowing between the battery packs 2C and 2D. Therefore, the laminated bus bars 3 electrically connected to the end electrode terminals 21A and 21B and to the end electrode terminals 22A and 22B between the battery packs 2A and 2B is larger in lamination number of the bus bars 5 than the laminated bus bar 4 electrically connected to the end electrode terminals 21C and 21D between the battery packs 2C and 2D.

The laminated bus bars 3 electrically connect the end electrode terminals 21A and 21B and the end electrode terminals 22A and 22B which are the same positive and negative electrodes between the battery packs 2A and 2B, so that the battery packs 2A and 2B are connected in parallel. Similarly, the laminated bus bars 4 electrically connect the end electrode terminals 21C and 21D and the end electrode terminals 22C and 22D which are the same positive and negative electrodes between the battery packs 2C and 2D, so that the battery packs 2C and 2D are connected in parallel. In addition, the laminated bus bars 3 electrically connect the battery packs 2A and 2B, so that a set of a battery pack group BP1 is formed. Similarly, the laminated bus bars 4 electrically connect the battery packs 2C and 2D, so that a set of a battery pack group BP2 is formed. That is, the battery module 1 according to the embodiment includes two sets of the battery pack groups BP1 and BP2.

In addition, one wire harness WH is branched and connected to the battery pack group BP1 and the battery pack group BP2 on the current input side (Y1 side) and the output side (Y2 side), respectively. In this embodiment, as described above, the end electrode terminals 21A to 21D on the current input side (Y1 side) are the same positive and negative electrodes, and the end electrode terminals 22A to 22D on the output side (Y2 side) are the same positive and negative electrodes. Therefore, as the wire harness WH is connected as described above, the battery pack groups BP1 and BP2 are connected in parallel.

Next, a work of assembling the laminated bus bars 3 and 4 and a work of electric connection between the battery packs 2A to 2D will be described. First, the work of assembling the laminated bus bars 3 and 4 will be described. First, the operator laminates the bus bars 5 of which the lamination number is defined in advance for each of the laminated bus bars 3 and 4 in the plate thickness direction. Herein, as described above, the laminated bus bar 3 has a larger lamination number of the bus bars 5 than the laminated bus bar 4. Therefore, in assembling the laminated bus bar 3, the operator prepares the bus bars 5 of which the number is larger than that of the bus bars 5 of the laminated bus bar 4 and laminates the bus bars 5 in the plate thickness direction. At this time, the operator aligns the curving directions of the deformation allowing portions 52 of the respective bus bars 5 in the same direction and laminates the bus bars 5 while pressing the deformation allowing portions 52 such that the deformation allowing portions 52 of the bus bars 5 adjacent to each other in the plate thickness direction are in contact with each other. Next, the operator installs the bus bars 5 in the laminated state in an injection molding machine (not illustrated). At this time, the operator provides the bus bars 5 in the laminated state to the insert mold such that at least the deformation allowing portions 52 are located inside the insert mold and the through holes 51a are located outside the insert mold. Next, the operator operates the injection molding machine, and thus, a resin member flows into the insert mold, and the covering member 6 is formed on the outer periphery of the bus bars 5 laminated. The bus bars 5 laminated are assembled by the covering member 6 in the state where the connecting portions 51 and the deformation allowing portions 52 adjacent to each other in the plate thickness direction are in contact with each other, and thus, the assembling of the laminated bus bars 3 and 4 is completed.

Next, the operator inserts the through holes 51a of the laminated bus bar 3 into the end electrode terminals 21A and 22A of the battery pack 2A and into the end electrode terminals 21B and 22B of the battery pack 2B, respectively. Next, the operator inserts the nuts 200 into the end electrode terminals 21A and 21B and the end electrode terminals 22A and 22B and moves the nuts 200 in the downward direction while screwing the end electrode terminals (stud bolts) 21A and 21B and the end electrode terminals 22A and 22B. When the laminated bus bars 3 are interposed between the battery cells 10 and the nuts 200 in the vertical direction and the nuts 200 cannot be further moved in the downward direction, fastening of the end electrode terminals 21A and 21B and the nuts 200 and fastening of the end electrode terminals 22A and 22B and the nuts 200 are completed, and thus, the electrical connection between the battery packs 2A and 2B is completed. Similarly, the operator inserts the through holes 51a of the laminated bus bar 4 into the end electrode terminals 21C and 21D and the end electrode terminals 22C and 22D between the battery packs 2C and 2D and inserts the nuts 200, and thus, the electrical connection between the battery packs 2C and 2D is completed. Next, the operator accommodates the battery packs 2A to 2D electrically connected by the laminated bus bars 3 and 4 in an accommodation space of a housing (not illustrated) and attaches a cover (not illustrated) which closes the accommodation space to the housing, and thus, the assembling of the battery module 1 is completed.

Next, a case where the separation distances between the end electrode terminals 21A to 21D and 22A to 22D in the respective battery packs 2A to 2D are changed in the battery module 1 will be described. In a case where the separation distances between the end electrode terminals 21A and 22A and the end electrode terminals 21B and 22B and between the end electrode terminals 21C and 22C and the end electrode terminals 21D and 22D between the battery packs 2A to 2D are changed, in the laminated bus bars 3 and 4, the deformation allowing portions 52 formed in the bus bars 5 are deformed such that the separation distances between the connecting portions 51 facing each other in the first direction are changed. The laminated bus bars 3 and 4 absorb the change amount in the separation distances between the end electrode terminals 21A to 21D and 22A to 22D between the battery packs 2A to 2D.

In this embodiment, each of the laminated bus bars 3 and 4 includes a plurality of bus bars 5 formed in an identical shape, and the operator can form each of the laminated bus bars 3 and 4 by laminating a predetermined lamination number of the bus bars 5 in consideration of the current-carrying capacity required for each of the laminated bus bars 3 and 4 such that the deformation allowing portions 52 overlap with each other in the plate thickness direction. For example, similarly to the related art, in a configuration of the laminated bus bars 3 and 4 where the bus bars 5 having different shapes according to the lamination order are laminated, the bus bars 5 formed in different shapes are managed so as to be distinguished from each other, and in the assembling of laminated bus bars 3 and 4, the operator needs to laminate the bus bars 5 having different shapes in a distinguished manner without making a mistake of the lamination order. As compared with this, in the laminated bus bars 3 and 4 according to the embodiment, it is unnecessary for the operator to distinguish the bus bars 5 from each other, and the operator has only to laminate the bus bars 5 formed in the identical shape in the plate thickness direction, so that it is possible to easily form the laminated bus bars 3 and 4.

In addition, in the laminated bus bars 3 and 4 according to the embodiment, the bus bars 5 to be laminated have an identical shape. Similarly to the related art, in a case where the laminated bus bars 3 and 4 are formed by laminating the bus bars 5 with different shapes according to the lamination order, a plurality of molds for forming the respective bus bars 5 are required. Particularly, like a case where the battery module 1 is configured by electrically connecting battery packs having different battery capacities to one vehicle, or a case where a specification value of a power output value differs according to a vehicle type, there is a case where a current value electrically conducting between the battery packs differs according to one battery module or the vehicle type. In this case, at least two or more laminated bus bars having different current-carrying capacities are required. Therefore, in a configuration of a laminated bus bar of the related art, as the number of types of laminated bus bars required is increased, a mold for forming bus bars having different shapes is required. In addition, in recent years, since a higher power output of the vehicle is required, the number of battery cells 10 mounted on the vehicle is increased. In other words, since the current value flowing between the battery packs is increased, the lamination number of the bus bars 5 in each of the laminated bus bars 3 and 4 is also increased, and more molds for forming the bus bars 5 in each of the laminated bus bars 3 and 4 are required. In contrast, for each of the laminated bus bars 3 and 4, since the bus bars 5 have the identical shape, only one mold for forming the bus bars 5 may be sufficient. For example, even in a case where two or more laminated bus bars are required, since one mold can cope with the case, it is possible to suppress the cost required for manufacturing the laminated bus bars 3 and 4.

In addition, each of the laminated bus bars 3 and 4 according to the embodiment is formed by laminating a plurality of the bus bars 5, and the deformation allowing portion 52 is formed between the connecting portions 51 in each of the bus bars 5. For example, in a case where the bus bars which electrically connect the end electrode terminals 21A to 21D and 22A to 22D between the battery packs 2A to 2D is one block-shaped mass, when the separation distances between the end electrode terminals between the battery packs, for example, the separation distances between the end electrode terminals 21A and 21B between the battery packs 2A and 2B are changed, it is difficult to deform the bus bar of the block-shaped mass so as to absorb the above-mentioned change amount. In addition, load is applied to the end electrode terminals 21A to 21D and 22A to 22D which are electrically connected to the bus bar of the block-shaped mass through the contact point physically in contact with the bus bar of the block-shaped mass. In contrast, in the laminated bus bars 3 and 4, since each bus bar 5 is a plate-shaped member and the deformation allowing portion 52 is formed in the bus bar 5, even if the separation distances between the end electrode terminals 21A to 21D and 22A to 22D between the battery packs 2A to 2D are changed, the deformation allowing portion 52 can be deformed so as to change the separation distance of the connecting portions 51 facing each other in the first direction. Therefore, the change amount in the separation distances between the end electrode terminals 21A to 21D and 22A to 22D between the battery packs 2A to 2D can be absorbed in the laminated bus bars 3 and 4, so that it is possible to suppress the load applied to the end electrode terminals 21A to 21D and 22A to 22D.

In addition, in a case where electric wires are used to electrically connect the end electrode terminals 21A to 21D and 22A to 22D between the battery packs 2A to 2D, in order to absorb the change amount in the separation distances between the end electrode terminals 21A to 21D and 22A to 22D between the battery packs 2A to 2D, it is necessary to prepare the electric wires which are longer than the separation distances, and it is necessary to connect the end electrode terminals 21A to 21D and 22A to 22D between the battery packs 2A to 2D in a loosened state. Particularly, in order to satisfy the recent increase in the power output of the vehicle, the number of battery packs is increased, and the battery packs are installed at a narrow pitch in the housing of the battery module 1. Therefore, in the configuration where the battery packs are electrically connected by the electric wires as described above, there is a possibility that the waste of the electric wires becomes large and an external member is caught in a region where the electric wire is loosened. In contrast, in the laminated bus bars 3 and 4, the deformation allowing portions 52 can absorb the change amount in the same manner as the electric wires, and lengths of the bus bars 5 in the first direction may be configured to be equal to the separation distances between the end electrode terminals 21A to 21D and 22A to 22D between the battery packs 2A to 2D, so that the length of the bus bar 5 can be configured to be the minimum necessary length. Therefore, it is possible to suppress the waste of the bus bars 5. In addition, it is possible to suppress the cost required for manufacturing the laminated bus bars 3 and 4.

In addition, each of the laminated bus bars 3 and 4 according to the embodiment includes a covering member 6 which has an insulating property and covers the outer periphery of the bus bars 5 in the laminated state. The covering member 6 is formed by inserting and injection-molding the bus bars 5 in the laminated state such that at least the deformation allowing portions 52 are located therein. Therefore, since the covering member 6 integrally retains the bus bars 5 laminated in the state where the connecting portions 51 of the bus bars 5 adjacent to each other in the plate thickness direction are in contact with each other in each of the laminated bus bars 3 and 4, as compared with a case where the bus bars 5 are laminated by inserting the through hole 51a into the end electrode terminals 21A to 21D and 22A to 22D with respect to each of the bus bars 5 in the process where the operator connect the laminated bus bars 3 and 4 to the end electrode terminals 21A to 21D and 22A to 22D, it is possible to improve handleability of the laminated bus bars 3 and 4, so that it is possible to improve workability. In addition, since the covering member 6 is formed by injection molding of the resin member, in a case where an external force is exerted on the laminated bus bars 3 and 4 and the deformation allowing portions 52 are deformed, the covering member can be deformed following the deformation of the deformation allowing portions 52. In other words, in the laminated bus bars 3 and 4, even in a case where the deformation allowing portions 52 are deformed by the covering member 6, since the deformation allowing portions 52 adjacent to each other in the plate thickness direction can be retained in the state where the deformation allowing portions are in contact with each other, it is possible to improve product reliability of the laminated bus bars 3 and 4 and the battery module 1.

The battery module 1 described above includes a plurality of the battery packs 2A to 2D, and in a case where the battery packs having the same number of battery cells 10 is configured as one set of a battery pack group, two or more sets of a battery pack group BP1 and a battery pack group BP2 exist. In addition, the battery module 1 includes the laminated bus bars 3 and 4 having a plurality of the bus bars 5 formed in an identical shape, and the laminated bus bars 3 and 4 are formed by laminating the bus bars 5 in the plate thickness direction. At this time, in the laminated bus bars 3 and 4, the lamination number of the bus bars 5 having an identical shape has only to vary so as to have current-carrying capacities in consideration of current values flowing between the battery packs 2A and 2B and between the battery packs 2C and 2D. Therefore, even in a case where the battery module 1 includes the plurality of battery pack groups BP1 and BP2, the laminated bus bars 3 and 4 can be easily formed, so that the battery module 1 can be easily formed.

In this embodiment, even though each of the laminated bus bars 3 and 4 is configured to have the covering member 6, the present invention is not limited thereto, but each of the laminated bus bars 3 and 4 may be configured without the covering member 6. In a case where each of the laminated bus bars 3 and 4 is configured without the covering member 6, in some cases, each of the laminated bus bars 3 and 4 is in the state where the deformation allowing portions 52 adjacent to each other in the plate thickness direction are pressed in during the lamination of the bus bars 5, so that the contact property of the connecting portions 51 adjacent to each other in the plate thickness direction may be lowered. Therefore, after the lamination of the bus bars 5, the connecting portions 51 are laser-welded to improve the contact property of the connecting portions 51 adjacent to each other in the plate thickness direction. With the configuration without the covering member 6, even in a case where the lamination number of the bus bars 5 in each of the laminated bus bars 3 and 4 is large, it is possible to prevent the thickness of each of the laminated bus bars 3 and 4 in the plate thickness direction from increasing by the covering member 6.

In the battery module 1 according to the embodiment, the battery pack groups BP1 and BP2 are configured to be connected in parallel by the wire harness WH. However, the battery pack groups BP1 and BP2 are not limited thereto, but the battery pack groups may be connected in series. For example, in a case where a plurality of battery pack groups connected in series by a plurality of types of vehicles are mounted and specification values of power output are different among the types of vehicles, the current values flowing between the battery pack groups are different among the types of vehicles. Even in the above-described case, in the laminated bus bars 3 and 4, since the lamination number of the bus bars 5 having an identical shape has only to vary, even in a case where the specification values of power output are different among the types of vehicles, it is possible to easily form laminated bus bars corresponding to the current values flowing between the battery pack groups.

In order to achieve the above-described object, in the laminated bus bar and the battery module according to the embodiment, in forming the laminated bus bar, an operator has only to laminate a plurality of bus bars having an identical shape such that deformation allowing portions overlap with each other in a plate thickness direction and connecting portions of the bus bars adjacent to each other are in contact with each other, it is not necessary to laminate the bus bars having different shapes in a distinguished manner, so that it is possible to obtain an effect capable of easily forming a laminated bus bar and a battery module according to the embodiment.

Although the present invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laminated bus bar comprising:
a plurality of bus bars formed in an identical shape, wherein
each of the bus bars is a plate-shaped conductive member formed to extend in a first direction,
each of the bus bars includes:
connecting portions formed at both ends in the first direction and electrically connect battery packs, each of the battery packs including a plurality of battery cells; and
a deformation allowing portion that is formed between the connecting portions and is curved in a plate thickness direction as viewed in a second direction perpendicular to the first direction, and
the bus bars are laminated such that the deformation allowing portions overlap with each other in the plate thickness direction, and the connecting portions of the bus bars adjacent to each other are in contact with each other.

2. The laminated bus bar according to claim 1, further comprising:
a covering member that has an insulating property, is made of a resin and covers an outer periphery of the bus bars in a laminated state, wherein
the covering member is formed such that at least the deformation allowing portions are located in the covering member, and the connecting portions are exposed to an outside of the covering member.

3. A battery module comprising:
a plurality of battery packs that include a plurality of battery cells therein; and
a plurality of laminated bus bars that include a plurality of bus bars formed in an identical shape, wherein
in the plurality of battery packs, in a case where at least two battery packs having the same number of battery cells are configured as a set of a battery pack group, at least two or more sets of the battery pack group exist, and in a case where the sets are different from each other, the number of battery cells in the one battery pack differs,
each of the bus bars is a plate-shaped conductive member formed to extend in a first direction,
each of the bus bars includes:
connecting portions formed at both ends in the first direction and electrically connect the battery packs, each of the battery packs including the plurality of battery cells; and
a deformation allowing portion that is formed between the connecting portions and is curved in a plate thickness direction as viewed in a second direction perpendicular to the first direction,
the bus bars are laminated such that the deformation allowing portions overlap with each other in the plate thickness direction, and the connecting portions of the bus bars adjacent to each other are in contact with each other, and
a lamination number of the plurality of laminated bus bars differs according to a current value flowing between the battery packs to be connected or between the battery pack groups to be connected.
